(19) United States
(12) Patent Application Publication
(10) Pub. No.: US 2025/0202582 A1
(43) Pub. Date: Jun. 19, 2025

(54) OPTICAL FRONTHAUL SPECTRAL EFFICIENCY FOR HYBRID FRONTHAUL

(71) Applicant: AT&T Communications Services India Private Limited, Bangalore (IN)

(72) Inventor: Mritunjay Pandey, Bangalore (IN)

(73) Assignee: AT&T Communications Services India Private Limited, Bangalore (IN)

(21) Appl. No.: 18/538,146

(22) Filed: Dec. 13, 2023

(51) Int. Cl. H04B 10/2575; H04J 3/16

(52) U.S. Cl. CPC H04B 10/25753; H04J 3/1658

(57) ABSTRACT

Aspects of the subject disclosure may include, for example, receiving network information about physical parameters of a fronthaul network of a mobility network, the fronthaul network including multiple network elements including optical communication elements of a radio access network of the mobility network, forming collected network information, receiving from a deep learning (DL) model, operating parameters for a channel in the fronthaul network, the operating parameters determined by the DL model for improved spectral efficiency in the channel between a first element and a second element in the fronthaul network, and launching the channel between the first element and the second element, wherein the launching the channel is according to the operating parameters. Other embodiments are disclosed.

### FIELD OF THE DISCLOSURE

The subject disclosure relates to system and method to improve spectral efficiency for an optical fronthaul network in a mobile communications network.

### BACKGROUND

Fronthaul refers to a communications connection among components of a cloud radio access network (C-RAN), a type of cellular network. The C-RAN generally includes centralized baseband units (BBUs) and remote radio heads (RRHs) at the access layer of the cellular network. Fronthaul includes standalone radio heads and baseband controllers located at remote cell sites. The radio heads are located at a cell site. The BBUs may be located at a central site to serve multiple RRHs. The network links that interconnect multiple RRHs and a BBU are called fronthaul. Fronthaul networks are generally optical networks. Passive optical networks (PONs) use optical splitters and point to multi-point topology for fronthaul communication. Wavelength division multiplexing (WDM) networks use optical signals to combine multiple signals at varying wavelengths for fiber optic transmission to enhance efficiency of fronthaul links.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a software defined access optical controller for use in conjunction with the system of FIG. 2A in accordance with various aspects described herein.

FIG. 2C shows measured relative scattered power (in dB) in a network segment.

FIG. 2D depicts an illustrative embodiment of a method in accordance with various aspects described herein.

FIG. 2E depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for selecting parameters for devices in a network such as an optical fronthaul network of a mobility network. A system and method include determining physical parameters the components and connections of the network, modeling topology in an artificial intelligence tool such as a machine learning model or deep learning model and receiving parameters for a new or modified channel on a connection between two components of the network. The new or modified channel may then be launched by the network to initiate communication between the two components. Other embodiments are described in the subject disclosure.

One or more aspects of the subject disclosure include collecting network information about physical parameters of an optical transport network, the optical transport network including multiple network elements, the network elements including at least one of a Central Unit (CU), a Distributed Unit (DU) and a Radio Unit (RU), forming collected network information, developing a machine learning (ML) model for characterizing at least a portion of the optical transport network, wherein the developing the ML model is based at least in part on the collected network information, selecting parameters for a communication channel between two network elements, forming selected parameters, and launching the channel between the two network elements according to the selected parameters.

One or more aspects of the subject disclosure include collecting information about physical parameters of an optical transport network in a mobility network, the optical transport network including multiple network elements, the network elements including at least one of a Central Unit (CU), a Distributed Unit (DU) and a Radio Unit (RU) for providing radio communication services to user equipment (UE) devices in a service area, forming collected network information, detecting a network failure in the optical transport network, receiving, from a model, suggested parameters for a modified channel in the optical transport network, the suggested parameters determined by the model to correct the network failure in the optical transport network, and launching the modified channel according to the suggested parameters.

One or more aspects of the subject disclosure include receiving network information about physical parameters of a fronthaul network of a mobility network, the fronthaul network including multiple network elements including optical communication elements of a radio access network of the mobility network, forming collected network information, receiving from a deep learning (DL) model, operating parameters for a channel in the fronthaul network, the operating parameters determined by the DL model for improved spectral efficiency in the channel between a first element and a second element in the fronthaul network, and launching the channel between the first element and the second element, wherein the launching the channel is according to the operating parameters.

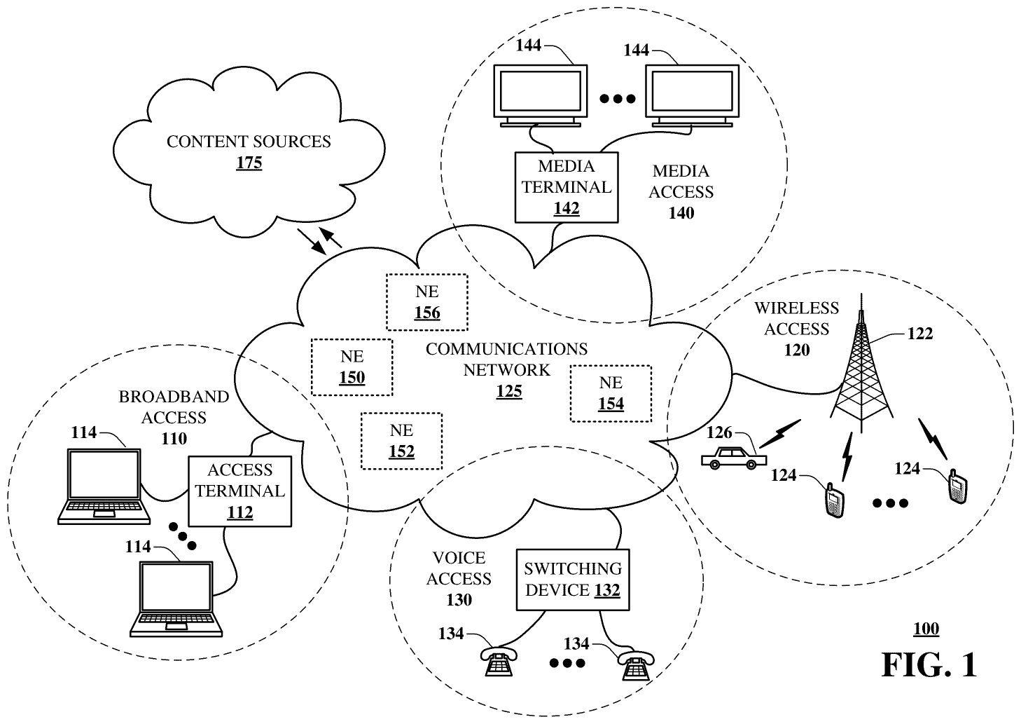

Referring now to FIG. 1, a block diagram is shown illustrating an example, non-limiting embodiment of a system 100 in accordance with various aspects described herein. For example, system 100 can facilitate in whole or in part determining physical parameters the components and connections of a network. The physical parameters of the network may be used to model topology using an artificial intelligence tool and parameters for a new or modified channel in the network may be received from the artificial intelligence tool, such as machine learning model or a deep learning model. The new or modified channel may then be launched by the network to initiate communication between the two components. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

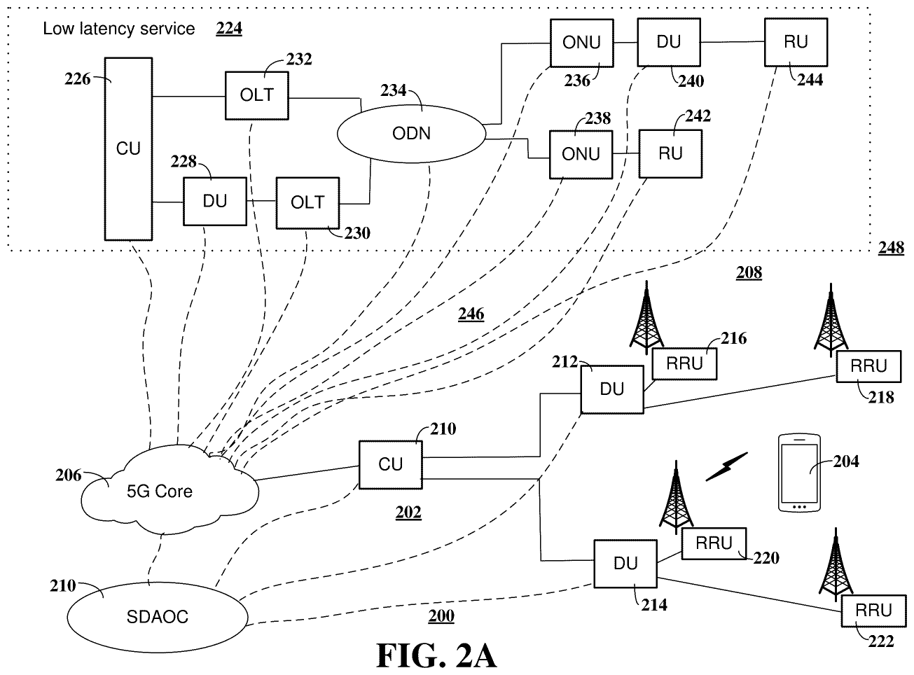

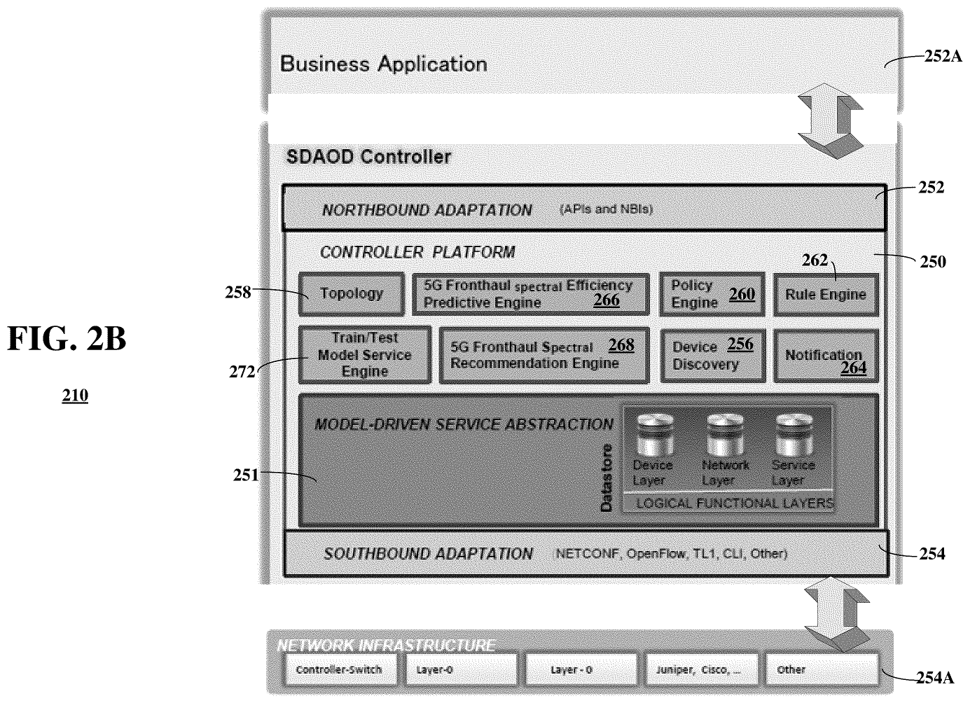

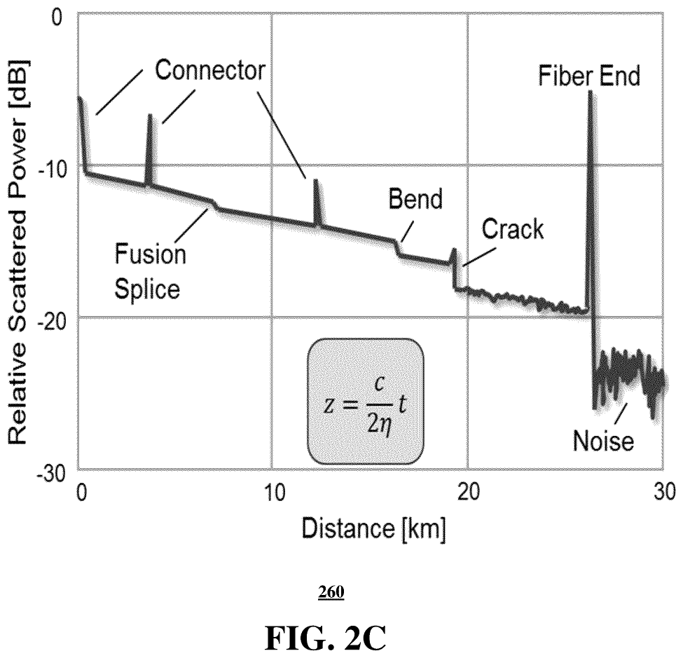

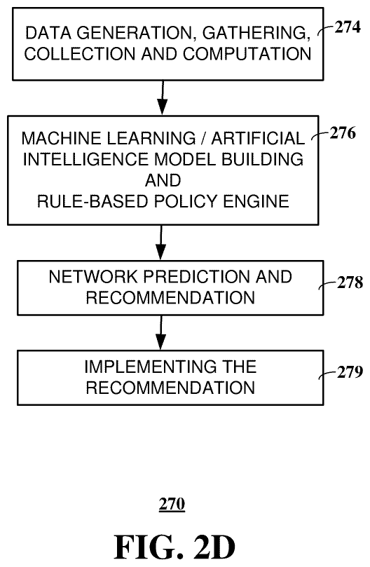

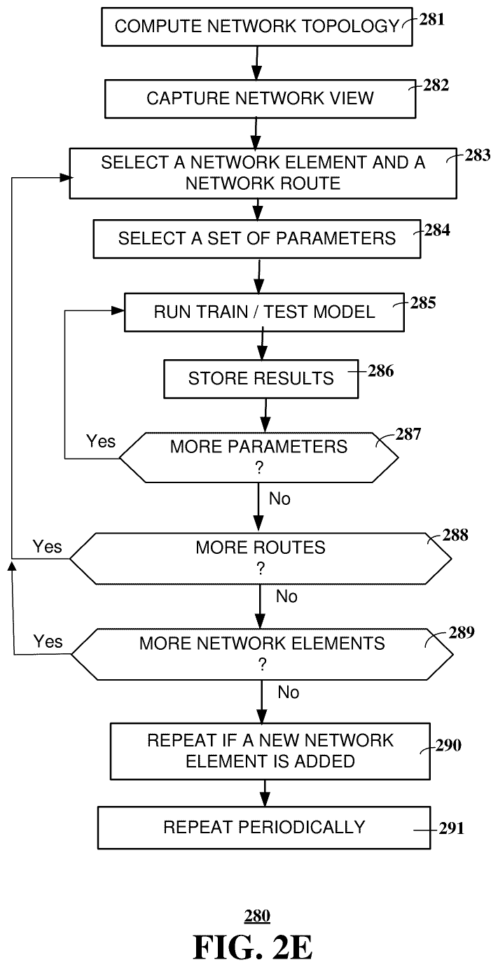

FIG. 2A is a block diagram illustrating an example, non-limiting embodiment of a system 200 functioning within the communications network 125 of FIG. 1 in accordance with various aspects described herein. The system 200 illustrates a fifth generation (5G) mobility network 202. The 5G mobility network 202 provides radio communication to user equipment (UE) such as UE device 204. The system 200 includes a 5G core network 206, a fronthaul network 208 and a software defined access optical controller (SDAOC) 210. The embodiment of FIG. 2A is intended to be exemplary only. Other embodiments will include different elements and different connections.

The 5G core network 206 may include any suitable combination of network functions for serving other elements of the 5G mobility network 202. The 5G core network 206 may be formed from any suitable combination of data processing systems including servers, switches, and other devices. In some embodiments, the 5G core network 206 is formed using 5G network slicing. Network slicing is a network architecture that enables the multiplexing of virtualized and independent logical networks on the same physical network infrastructure. Each network slice is an isolated end-to-end network tailored to fulfill particular requirements of a particular application or function.

The components of the 5G core network 206 implement a number of discrete network functions. Such network functions include an access and mobility function (AMF), an authentication server function (AUSF), a session management function (SMF), a network slice selection function (NSSF), and others. The network functions enable communication among the components of the 5G core network 206 as well as communication between user equipment such as the UE device 204 and the components of the 5G core network 206. Further, the 5G core network 206 may provide one or more gateways to external networks such as the public internet for access by the UE device 204 and other devices. In some embodiments, the components of the 5G core network 206 are cloud native and may be distributed over multiple locations and accessible by one or more data networks.

The fronthaul network 208 includes a centralized unit (CU) 210 in communication with the 5G core 206 and two distributed units (DUs), including DU 212 and DU 214. The CU 210 provides control of the respective DUs, DU 212 and DU 214, in the 5G mobility network 202. The CU 210 is a logical node that performs a subset of eNodeB or gNodeB functions. The eNodeB or eNB or gNodeB or gNB is the network component of 5G mobility network 202 that communicates directly, wirelessly, with mobile devices such as the UE device 204. Such functions may include transfer of user data, mobility control, radio access network sharing, positioning, session management, for example. The CU 210 provides baseband central control. The CU 210 generally controls the respective DUs. The split of functionality between the CU 210 and DUs such as DU 212 and DU 214, is established by the network operator.

The DU 212 and the DU 214 are logical nodes that perform a subset of eNodeB or gNodeB functions. Each respective DU provides mobile radio communication service to user equipment devices such as the UE device 204 located in the respective cell served by the DU. Each DU including DU 212 and DU 214, is in communication with the CU 210. In some embodiments, each respective DU is a remote radio head (RRH) or remote radio unit (RRU), providing radio frequency (RF) communication with UE in each respective cell. Thus, DU 212 includes a RRU 216 and is also in communication with a remote RRU 218. Similarly, the DU 214 includes an RRU 220 and is in communication with a remote RRU 222. Each DU may communicate with the CU 210 using fiber optic cable or other means of data communication. Fiber optic cables are indicated in dashed lines in FIG. 2A.

The fronthaul network 208 of the 5G mobility network 202 further includes a low latency service 224. The low latency service 224 includes a CU 226, a DU 228 and a first optical line termination (OLT) 230 along with a second OLT 232. The first OLT 230 and the second OLT 232 are in data communication with an optical distribution network (ODN) 234. Further in communication with the ODN 234 is a first optical network unit (ONU) 236 and a first DU 240 along with a second ONU 238 and a first RU 242. A second radio unit (RU) 244 is in data communication with the first DU 240.

The OLT 230 serves as the service provider endpoint of a passive optical network (PON) 234. The OLT 230 operates to convert between electrical signals used by the service provider's electrical equipment and fiber optic signals used by the PON. Further, the OLT 230 operates to coordinate multiplexing between conversion devices on the far end of the PON, specifically the first ONU 236 and the second ONU 238 in the example of FIG. 2A. The PON 234 is a fiber optic communications network for delivering broadband network access to end-users. A PON such as the PON 234 generally implements a point-to-multipoint topology in which a single optical fiber serves multiple endpoints by using optical splitters to divide the fiber bandwidth among the endpoints. The PON 234 generally includes the OLT 230 at the service provider's endpoint, one or more splitters and a number of ONUs such as the first ONU 236 and the second ONU 238. A PON such as PON 234 reduces the amount of fiber and central office equipment required compared with point-to-point architectures. A PON is a form of fiber-optic access network.

The first ONU 236 and the second ONU 238 are used to terminate the fiber optic connector and demultiplex the optical signal. RU devices such as the first RU 242 and the second RU 244 operate to convert radio signals between an antenna and digital signal received at the ONU 238 and the DU 240, respectively. Connection between an RU and the ONU 238 and the DU can be optical or electrical such as Ethernet.

Components of the low latency service 224 are in data communication with the 5G core 206 to communicate data and control information. Further, the components of the fronthaul network 208 are in data communication with the SDAOC 210 either directly through fiber or electrical connections or indirectly through the 5G core 206.

As exemplified in FIG. 2A, the mobility network 202 can be divided into three layers including the 5G core 206, a transport network 246 and a radio access network or RAN 248. The RAN 248 includes radio access devices such as RRU 216, RRU 218 and RU 244 and provides wireless communication between an RRU or an RU and a user device such as UE device 204. The transport network 246 provides data communication between the 5G core 206 and the components of the RAN 248. The transport network includes CU devices such as CU 210 and CU 226 as well as DU devices such as DU 212, DU 228 and the ODN 234 and associated components. The transport network 246 in the example of FIG. 2A thus includes CU devices, DU devices and RU or RRU devices.

The fronthaul network 208 thus enables communication between the 5G core 206 and radio units such as RRU 220 in wireless communication with user devices such as UE device 204. The communication includes both user data communicated with the UE device 204 and control data for controlling components of the fronthaul network 208. The fronthaul network 208 is generally composed of optical elements for high speed, reliable communication. Multiple channels may be defined in the optical fibers connecting the components of the fronthaul network 208. As the mobility network 202 including the transport network changes and evolves to serve customers, the fronthaul network 208 evolves as well.

In a 5G optical fronthaul network such as the fronthaul network 208, several parameters can affect reliable communications. Such factors may include the distance between DUs, CUs and RUs. For example, the CU 226 and the DU 228 may be physically close together, but they communicate with RU 244 which in the example is too far away for reliable communication. In the example, a distance that is too great or too far may be determined in any suitable manner such as an error rate exceeding a predefined threshold because optical communications do not reach the far end of the connection. In another example, the DU 240 and the RU 244 are physically close, but they communicate with a CU 226 that is too remote for reliable communication. Again, remoteness may be determined according to any suitable standard or according to any suitable threshold such as a maximum available data rate, an acceptable error rate, a minimum throughput, etc. Distance between components may affect, for example, latency in communication between components or reachability of one component by another one. For example, in a small cell architecture, connection density is relatively high and many radio units may serve a particular area. However, the distance to each RU from a DU or CU may vary for each unit, which can affect the optical frequencies chosen for communication with the respective RU devices. In other areas, the connection density is lower and the choice of optical frequencies in a network is substantially different.

Other optical network parameters affecting reliable communications in the fronthaul network 208 include a non-uniform gain profile across frequencies for a portion of the network; absorption losses; scattering such as Rayleigh scattering and Mie scattering; a dispersion profile in which phase velocity of an optical wave varies with its frequency; and various optical fiber characteristics. When assigning a communication channel in the optical network, one challenge is finding a best spectrum location for the channel to ensure reliable communication from source to destination through all components of the network.

Moreover, the fronthaul network 208 can change over time. Such changes in optical characteristics can affect existing channels defined on the fronthaul network 208. Such changes can cause a delay or other issues when launching a new channel. For example, expanding capacity by adding more high-capacity channels can produce refractive index changes due to nonlinearity. Twists in the optical fiber can cause polarization mode dispersion. Laser characteristics can change over time, creating for example amplified spontaneous emission (ASE) noise.

Conventional networks such as the 5G mobility network 202 lack a capacity or capability to learn the characteristics of the entire network, including a WDM network. Further, conventional networks lack the ability to do analytics on network data to analyze and resolve problems in the network, such as low throughput, excessive latency or excessive bit error rate. Still further, conventional networks lack the ability to collect network parameters at run time and use that data to learn characteristics of a 5G optical fronthaul network. This learning can be used to make intelligent decisions about the network and its components when adding new channels, cutting the fiber, adding new fiber segments, etc.

In accordance with various aspects described herein, the SDAOC 210 can learn the parameters and characteristics of the fronthaul network 208. For example, the SDAOC 210 can learn the topology of the fronthaul network 208 as well as the physical characteristics of the fronthaul network 208 including the fiber connections between components. The SDAOC 210 can learn what frequencies to use for communication in the fronthaul network 208 as well as what type of modulation to use for a particular desired data rate. Further, the SDAOC 210 can store information about the physical characteristics, such as in a database at the SDAOC 210. The SDAOC 210 can then automatically determine if future demands of the fronthaul network 208 can be met by the current network and provide required modifications to meet future demands. Further, the SDAOC 210 can compensate for or correct changes or variations in such parameters or characteristics to improve reliability of communication in the fronthaul network 208.

In an embodiment, the SDAOC 210 includes a discovery engine to determine or discover the network topology for the network. For example, the discovery engine may identify node hops and other connections in the network. The discovery engine may further note neighbor information, including information about each network component it encounters (such as a CU, a DU or an RU) and detailed technical information about the connections available between the nodes. The discovery engine can get data from each node defining what links are available at the node and what connections are established between nodes. Once the information about network topology is gathered, the SDAOC 210 can form a model of the network.

Once the network and its topology and components have been modeled, the SDAOC 210 can make predictions and recommendations for the network based on inputs and requirements provided to the SDAOC 210. For example, the SDAOC 210 can receive or determine information about a network density and a customer's data rate requirement and, based on the collected information or the model of the network, recommend or specify a latency requirement or a frequency or modulation type for the particular customer served by the network. In another example, reachability varies with network parameters and the frequency being used for data communication. The SDAOC can receive as an input a desired or required reachability for a network segment and respond by recommending network parameters such as network topology, transmission frequency, modulation scheme and others to achieve that specified reachability for a particular network element or connection between two nodes.

A network operator associated with the system 200 can employ the SDAOC 210 to determine network parameters and develop recommendations from the SDAOC to satisfy design goals for the network. The network operator can then use the recommendations from the SDAOC to build out or modify the mobility network 202 and its components to achieve the desired goals. For example, some network connections may be upgraded from copper wire to fiber and optical connections. Some fiber connections may be improved, replaced or supplemented to increase throughput on a segment. Some network components such as a CU, DU or RU may be improved or supplemented to improve performance of network segments. In response to the recommendations of the SDAOC 210, the network operator may dispatch equipment, technicians or a combination to make necessary network modifications.

FIG. 2B is a block diagram illustrating an example, non-limiting embodiment of a software defined access optical controller (SDAOC) 210 for use in conjunction with the system of FIG. 2A in accordance with various aspects described herein. The SDAOC 210 in the exemplary embodiment includes a controller platform 250, a model driven service abstraction 251, a northbound adaptation function 252, and a southbound adaptation function 254. Other embodiments may include additional, fewer or alternative features.

In the illustrated embodiment, the northbound adaptation function 252 enables data communication with any suitable business applications 252A. A northbound interface is an application programming interface that allows a lower-level network component to communicate with a higher level or more central component, such as a business system. For example, a business application 252A may provide command and control information to the SDAOC 210 to control the device or receive from the SDAOC 210 information about the fronthaul network 208 with which the SDAOC 210 is associated. The southbound adaptation function 254 may provide a communication interface with elements of the network infrastructure 254A. A southbound interface allows a higher-level component to send commands to lower-level network components. The network infrastructure 254A may include any network components such as CUs, DUs, RUs and other switches, routers and devices. Thus, the southbound adaptation may be configured to exchange data according to any suitable protocol such as Network Configuration Protocol (Netconf), a network management protocol; Openflow, a software defined networking standard: Transaction Language 1 (TL1), a management protocol; a command line interface (CLI), or other data communication format. Further, the network infrastructure 254A may include devices manufactured or provided by various vendors.

The model driven service abstraction 251 in embodiments operates as a model of the network under analysis, such as fronthaul network 208. The model driven service abstraction 251 is formed by collecting data by the components of the controller platform 250. For example, as the device discovery module 256 collects data about links and devices in the network, information about the links and devices is abstracted by the model driven service abstraction 251. Abstraction of the information may include any suitable processing including developing a functional model of cooperation among the links and devices of the network. In the example, the data of the model are segregated into a device layer, a network layer and a service layer. Data may be organized along other logic functional layers as well.

In the example, the SDAOC 210 including the model driven service abstraction 251 is a notification-based architecture. For example, if a node of the network infrastructure 254A changes in some way, such as if a node is added or removed from the network, information about the modification will be received by the SDAOC 210 at the southbound adaptation 254. The model driven service abstraction 251 responds to the received change by changing the model. The change to the model is notified by the notification module 264 to the topology module 258 and the topology defined by the topology module 258 is updated. If any change to the topology of the fronthaul network 208 is made, such as adding more RUs or adding a branch to the fronthaul network 208, that change is reflected in the model driven service abstraction 251 and thereby to the topology module 258.

The controller platform 250 in this example, includes a device discovery module 256, a topology module 258, a policy engine 260, a rule engine 262, a notification module 264, a 5G fronthaul spectral efficiency predictive engine 266, a 5G fronthaul spectral recommendation engine 268, and a train and test model service engine 272. Other embodiments may include additional, fewer or alternative features.

The device discovery module 256 operates to determine the contents and structure of a network such as the fronthaul network 208 of FIG. 2A. Any suitable network analysis routine may be used to identify nodes in the network and to interrogate each respective node to learn the capabilities of the node. In an example, the device discovery module 256 characterizes each link between nodes. For example, the device discovery module may employ any suitable device such as an optical time domain reflectometer to characterize physical parameters of each link. Once the respective links are characterized, the topology module 258 collects data from each of the identified network elements. Each discovered node may be one of a CU, a DU, and RU, an optical network component or other switching or coupling device. The device discovery module 256 identifies additional nodes in communication with each discovered node and, in turn, interrogates the additional nodes. The device discovery module 256 may produce output results in any suitable fashion, such as in a database of devices, links and capabilities.

The topology module 258 receives from the device discovery module 256 the information about the devices and links in the network. For example, the topology module 258 develops a model of the data connections between the devices of the network in conjunction with the model-driven service abstraction 251. Based on this information, the topology module 258 models the topology of the network, including modeling individual devices such as CU devices, DU devices and RU devices in data communication with a core network such as the 5G core network 206 of FIG. 2A. The topology module 258 may retrieve stored information about particular devices or connections, such as device capabilities for a particular model of a device. In some embodiments, the devices are designed, manufactured or sold by different vendors. Each respective vendor may use a respective protocol for communication and management of the device. The topology module 258 identifies a vendor of each device and retrieves any necessary information for characterizing the device. The model for the data connections may include any suitable information, such as frequency response, gain response, and any abnormal response aspects that have been uncovered by the device discovery module 256.

The 5G fronthaul spectral efficiency predictive engine 266 receives analyzed data from the train and test model service engine 272. The 5G fronthaul spectral efficiency predictive engine 266 operates to predict the spectral response of the fronthaul network 208 including spectral efficiency for the given topology of the network. The policy engine 260 operates to enforce predefined policies on the network. The policies may be established by the network operator or by a standard such as the 3GPP standard defining 5G fronthaul technology and interoperability. The rule engine 262 operates similarly, to define and enforce network design and operation rules to ensure reliable operation. For example, standards such as those published by 3GPP define operational rules which must be adhered to for compliance with other equipment.

The 5G fronthaul spectral recommendation engine 268 receives information from the 5G fronthaul spectral efficiency predictive engine 266 including information about the predicted spectral response for components and links in the network. The 5G fronthaul spectral recommendation engine 268 operates to determine, based on the topology of the network, what spectrum should be tuned on the network to ensure the network will satisfy 5G specifications for fronthaul networks.

The SDAOC 210 may support the widest range of data rates in the network or portions of the network. Data rates used by the SDAOC may vary substantially. Required data rates may depend, for example, on the density of small cells used in the mobility network 202 and accessed by the fronthaul network 208. Based on those data rates, the capacity of the connections within the fronthaul network 208 are selected. Higher data rate requirements will in turn require larger capacity optical connections in the fronthaul network 208. Such data rates may range from 20 Mbps or less to 40 Gbps or more.

Further, the SDAOC 210 may support a wide range of modulation formats, including quadrature amplitude modulation (QAM), probabilistically shaped quadrature amplitude modulation (PS-QAM), and others as well including 16-QAM, 64-QAM and others. Further, the SDAOC 210 supports forward error correction (FEC) including standard FEC, enhanced FEC, ultra-FEC and adaptive FEC. The modulation technique is tied to the reachability of portions of the network. For example, if 64-QAM is used, the reachability for data is substantially reduced compared with 32-QAM. Still further, for communicating with other components of the system 200, the SDAOC 210 may communicate using Ethernet, optical transport network (OTN) protocols, fiber channels and others that may be suitable. The train and test model service engine 272 will predict spectral efficiency of a channel between the 5G CU and DU and the RU and make recommendations.

The train and test model service engine 272 operates to analyze the data collected about the network including network components and network links and select transmission parameters for a link. For example, the train and test model service engine 272 receives information about possible data rates in the link, available modulation techniques, available forward error correction techniques, along with other available information. In embodiments, the test and train model service engine 272 operates to select among possible data rates (such as 20 Mbps).

s or 40 Mbps), among modulation techniques (such as 16-QAM or 64-QAM), and among forward error correction rates and other factors as well. The train and test model service engine 272 selects the best values for rapid, reliable communication.

For example, the SDAOC 210 in general and the 5G fronthaul spectral efficiency predictive engine 266 operates to determine a number of parameters, as follows.

Spectral efficiency:

$$Spectral efficiency = {log}_{2} ( M ) / ( \frac{N}{2} )$$

where M is number of symbols and N is dimensionality.

In embodiments, spectral efficiency may be calculated for all combinations of provisioning parameters.

Asymptotic power efficiency:

$$APE = γ = \frac{{d}_{min}^{2}}{4 {E}_{b}} = {d}_{min}^{2} {log}_{2} ( M ) / 4 {E}_{s}$$

Average symbol rate:

$$ASE = {E}_{s} = \frac{1}{M} {\sum }_{k = 1}^{M} {‖ {c}_{k} ‖}^{2}$$

Average energy per bit:

$${AE}_{b} = {E}_{s} / {log}_{2} ( M )$$

Attenuation:

$${α}_{dB} * L = 10 {log}_{10} \frac{{p}_{i}}{{p}_{0}}$$

where α_{dB} represents signal attenuation per unit length in decibels and L is an optical length. pᵢ is launch power and p₀ is received power.

Stimulated Brillouin Scattering or SBS:

$${P}_{B} = 4.4 \times {10}^{- 3} {d}^{2} {λ}^{2} {α}_{dB} v watts$$

Stimulated Raman scattering or SRS:

$${P}_{R} = 5.9 \times {10}^{- 2} {d}^{2} λ {α}_{dB} watts$$

where d and λ are fiber core diameter and operating wavelength, measured in micrometers. α_{dB} is fiber attenuation in dB per kilometer and v is bandwidth of the injection laser. Computation of SBS and SRS help keep launch powers of channels in control to avoid these scatterings in fiber.

Rayleigh scattering:

$${Γ}_{R} = \frac{8 {π}^{3}}{3 {λ}^{4}} {n}^{8} p 2 {β}_{c} {KT}_{F 1}$$

where F_{R} is the Rayleigh scattering coefficient, A is an optical wavelength, n is the refractive index of the medium, p is the average photoelastic constant, β_{c} is the isothermal compressibility at a fictive temperature T_{F} and K is Boltzmann's constant. So, for a constant refractive index, the remaining parameters are constant. The result therefore depends solely on the wavelength of light. Using the above relation, RC can be determined for each wavelength.

Material dispersion:

$$M = \frac{λ}{c} \vert \frac{{d}^{2} {n}_{1}}{c d {λ}^{2}} \vert$$

RMS pulse broadening is given by:

$${σ}_{m} \approx \frac{{σ}_{λ} L}{c} \vert λ \frac{{d}^{2} {n}_{1}}{c d λ} \vert = {σ}_{λ} LM$$

Dispersion in a single mode fiber:

Group delay for a light pulse propagating along a unit length of SM fiber may be given as:

$${τ}_{g} = \frac{1}{c} \frac{d β}{{d}_{k}} ,$$

to a first order.

Using these relations, a model such as the model-driven service abstraction 251 of the SDAOC 210 operates to predict parameters including a spectral efficiency of a channel between a 5G CU, DU and RU in a 5G fronthaul network and to make recommendations to improve parameters such as spectral efficiency. The model employs flexible modulation formats, data rates, forward error correction schemes and other communication features to tune a channel, its bandwidth and to optimize reachability in the network.

FIG. 2C shows measured relative scattered power (in dB) in a network segment. FIG. 2C shows variation in relative scattered power along the length of the network segment. In general, along the length of the network segment, moving from left to right in FIG. 2C, relative scattered power decreases as power is lost along the length of the segment. Further, inconsistencies in the network segment cause spikes or jumps in relative scattered power. Such inconsistencies illustrated in FIG. 2C include the presence of connectors in the fiber cable, a fusion splice in the fiber cable, a bend and a crack in the fiber cable and the physical end of the fiber cable. Other physical anomalies may result in similar performance variation as well.

The data collected and modeled by the model-driven service abstraction 251 of the SDAOC 210 (FIG. 2B) can model the actual measured values for signals in the network segment. Moreover, the SDAOC 210 can predict factors such as what frequency to select for a network segment and how reachability will be affected by selected signal parameters. The SDAOC can determine what is the best spectrum to use for a given use case in the fronthaul network 208. In an example, the SDAOC 210 can operate to ensure that there is no decrease in quality of service or quality of experience for users. For example, there may be a surge in usage on the fronthaul network 208 due to a particular event, such as a concert or meeting that attracts a lot of users and their associated traffic. In that case, the connection density will increase for a period of time. The SDAOC 210 can determine suitable spectral features so that there is no drop in quality of experience for that surge of users.

FIG. 2D depicts an illustrative embodiment of a method 270 in accordance with various aspects described herein. The method 270 may be used in conjunction with a software defined access controller such as the SDAOC 210 of FIG. 2B to predict spectral efficiency of channels between 5G Central Unit (CU) and Distributed Unit (DU) and Radio Unit (RU) devices in a fronthaul network such as fronthaul network 208 of FIG. 2A, and to develop a recommendation for optical network design.

In particular use cases, the method 270 may be used to solve particular problems in active, installed networks such as the fronthaul network 208 of FIG. 2A. For example, in a 5G fronthaul network employing wave division multiplexing in a passive optical network (PON), if all WDM channels are already exhausted or occupied with current data carriers on a particular path between components in the network, it may be the case that the network has no spare capacity to cater to additional traffic demand for that path. In another example, there may not be enough spectrum available in the optical network to meet current and future traffic demands. A 5G optical network may have signal strength and other performance indicators affected by a variety of parameters, including distance between components such as DUs, CUs and RUs; gain profiles; absorption losses in fiber or other media; scattering such as Rayleigh scattering and Mie scattering; a dispersion profile and other optical fiber characteristics. The method 270 may operate to find an optimal or best spectrum location, or communication channel for a particular optical connection between components in the path.

In another user case, changing optical characteristics of a network such as the 5G optical fronthaul network may hinder launching new channels in a particular optical connection or may impact existing channels. For example, adding more high-capacity channels may cause a change in refractive index due to non-linearity effects. Further, polarization mode dispersion (PMD) may be caused by mechanical factors such as twists or bends in an optical fiber. Amplified spontaneous emission (ASE) noise may change due to increased amplification needs. Further, laser characteristics may change over time.

A method and device with aspects similar to those of the SDAOC controller 210 of FIG. 2B may operate to learn relevant physical characteristics of an optical fronthaul network such as the fronthaul network 208 of FIG. 2B. The learned physical characteristics may be used to resolve the network problems noted above. The learned physical characteristics may be used to create a database, model or other resources for access and analysis by one or more applications. The applications may predict future needs for network resources. The applications may predict if future demands of the network can be met by the current network and then achieving this result.

The method 270 may be performed by any suitable data processing system including a processor and memory. The memory may include a database or similar data storage component. The processing system may be located at any suitable location and may have access to components of the network under test, such as the fronthaul network 208 of FIG. 2A. For example, the processing system may be located together with one or more of the components of the network under test. Alternatively, the processing system may be located remotely from the network or may be virtualized among one or more software defined network components or slices. The method 270 may be initiated by any suitable process, such as a network operator seeking to troubleshoot a performance issue in the network or to identify potential problems in the network or to predict and plan future performance in the network.

The method 270 includes a first step 274 of data generation, data gathering, data collection and computation. Step 274 may be a preliminary step or a precursor step. Step 274 may be performed in whole or in part from time to time as aspects or components of the network under test change, as traffic levels change, or for any other reasons.

FIG. 2E depicts an illustrative embodiment of a method 280 in accordance with various aspects described herein. The method 280 may correspond to step 274 of method 270. The steps of method 280 may be performed to implement the data generation, gathering, collection and computation aspects of step 274 of method 270. The method 280 may be modified to include some, all or additional steps relative to those shown in FIG. 2E.

At step 281, the SDAOC 210 or a similar device or process may determine a topology of the network. Step 281 may include retrieving information about components such as CUs, DUs, RUs, and other communication components operating on the network. This may be done in real time, while the network is operating and communicating data. For example, step 281 may include contacting a first network component and inquiring about active communication links of the first network component along with other components in communication with the first network component. Step 281 may include further polling components and connections to identify equipment including network connections of an optical network. The received information may be stored as received.

Step 282 may include capturing a network view. In an example, a model may be developed to define each component in the network and each component with which it communicates, as well as parameters of the communication link between the components. The network view may be prepared and saved as a model in which one or more components can be simulated to see effects on network behavior and performance.

At step 283, a first network element and a first network route in the model is selected. Any process or criteria may be used for selecting an initial element or route. A looping process will eventually select all elements for analysis.

At step 284. a set of parameters for the selected network element and the selected network route is selected. The selected parameters may be parameters related to communication by the selected network element and the selected network route. For example, the parameters may include a set of WDM channels used by the selected network element for communication over the selected network route. The parameters may include data rates, bandwidth, a gain profile, absorption losses, and other factors.

St step 285, a model such as the train/test model service 272 may be run. The train and test model service engine 272 or other model may operate in conjunction with a rule engine such as the rule engine 262 and a policy engine such as the policy engine 260 of the SDAOC 210 of FIG. 2B. The model operates to analyze the data collected at step 281 about the network including network components and network links and select transmission parameters for a link. For example, the train and test model service engine 272 receives information about possible data rates in the link or selected route, available modulation techniques, available forward error correction techniques, along with other available information. In embodiments, the test and train model service engine 272 operates to select among possible data rates (such as 20 Mbps or 40 Mbps), among modulation techniques (such as 16-QAM or 64-QAM), and among forward error correction rates and other factors as well. The train and test model service engine 272 stores the results of its analysis ate step 286.

At step 287, the method 280 includes determining if there are more parameters to analyze. If so, control returns to step 285 to further run the train/test model for analyzing parameters for the selected network element and selected network route. The loop of steps 284, 285, 286 and 287 may continue until all network and communication parameters of the selected network element and the selected network route are analyzed.

At step 288, the method 280 includes determining if there are more network routes from the selected network element to analyze. In an example, a CU may be the selected network element. The CU may have as a first network route, a first optical connection to a first DU, a second network route including a second optical connection to a second DU and a third network route including a third optical connection to an RU. Each of these respective connections is considered and evaluated independently in the looping of step 283, step 284, step 285, step 286, step 287 and step 288.

Similarly, at step 289, the method 280 considers if there are more network elements for analysis. If so, control returns to step 283 where a next network element is selected along with one of the network routes associated with the next selected network element. Control proceeds through the various looping operations, running the test/train model for each connection for each component and storing results for each set of parameters. The process of method 280 continues until all nodes of the network have been analyzed and data stored.

At step 290, if a new network element is added, the process of method 280 is repeated to characterize the new element and any network connections established for the new network element. In embodiments, the entire analysis process of method 280 may repeated, or only portions of the model or data may be re-analyzed if they are affected by the network change. Similarly, if a network element or component is removed from the network, some or all of the steps of method 280 are repeated to maintain current data and models. Still further, if a component is replaced with another component, even a functionally similar component, some of all of the steps of method 280 may be repeated to maintain current data and models.

In some embodiments, step 291 may be performed and some or all of the operations of method 280 may be repeated periodically or as needed or on any other basis. For example, a laser in an optical connection may degrade over time or due to varying operating conditions. Equipment may vary over time and step 290 attempts to keep the model and the data on which the model is based fully up to date and to accommodate such changes.

Referring again to FIG. 2D, following completion of step 274, the method 270 includes at step 276 an operation to build a model and a rule-based policy engine. In examples, a machine learning (ML) model or a deep learning (DL) model may be built based on the data collected and processed in step 276. Any suitable model may be chosen, including a random forest ML model or a topology-based ML model. A DL model is essentially a neural network with three or more layers which attempts to simulate behavior in the communications network. Any suitable training data may be used to train an ML model or DL model, or an unsupervised model may be selected. Any other artificial intelligence process may be put in place to collect, organize or process the data collected at step 274.

The rule-based policy engine may include a policy engine 260, a rule engine 262 as in SDAOC 210 of FIG. 2B, or some combination of these. The rule-based policy engine may put in place and enforce certain predetermined rules or policies. Examples include network communication rules for compatibility between the network under test and other networks, such as standards published by 3GPP. Other examples may include solid engineering practices for key performance indicators or design guidelines like link margins and redundancy.

In accordance with step 276, data from the detected topology may be provided to the model for analysis. Such data may be retrieved as stored, step 286, FIG. 2E, or retrieved or obtained from any suitable source. Step 276 operates to perform a continuous analysis on learned network characteristics. In an example, the step 276 may operate to make decisions about a channel between, for example, components of a 5G fronthaul network, such as a CU, a DU and an RU.

Step 276 may include selecting parameters, based on the model, for a channel with optimal spectral efficiency for the particular connection between particular network elements. The spectral efficiency of a communication technology is the bit rate per unit bandwidth and includes all of the necessary overhead channels. Spectral efficiency in communications is the data rate that can be transmitted over a given bandwidth in a communication system. It is expressed as ‘bits-per-second per-hertz, (bits/s/Hz) and can be defined as the net data rate in bits-per-second divided by the bandwidth in hertz. In an example, an increase in demand for transmission capacity in optical fiber, such as the links connecting CUs, DUs and RUs in a 5G optical fronthaul network, requires an increase in optical spectral efficiency.

At step 278, the method 270 includes a process of making predictions and recommendations for the network based on results of data collection and analysis (step 274) and modeling (step 276). The model developed at step 276 may be used to predict and forecast future trends in a particular 5G fronthaul network. For example, training data for the network may include historical information about parameters, capacity, demand and other factors for the network. The ML model or DL model, using current data from the topology collected at step 274, may make a prediction about future network demands and requirements. Predictions may be used to modify the network, such as by adding additional components to accommodate future demand or expanding capacity of current network elements to accommodate future demand. As an example, the bandwidth of a particular link may be increased to increase capacity, or a single fiber connection may be upgraded with multiple fibers to increase capacity. Further, the network maybe segmented by installing more RUs to create more microcells and vary the traffic load within the existing network. In particular, using learning about network structure and operation over a period of time, step 276 may predict and forecast spectral efficiency for a channel between a 5G CU, DU or RU.

In another example involving the SDAOC 210 of FIG. 2B, the SDAOC 210 recommends parameters of a channel having the best or optimal spectral efficiency between a selected 5G CU (Central Unit), DU (Distributed Unit) and RU (Radio Unit) in the network. As an example, one of the network elements and network routes selected and analyzed at step 284 and step 285 of method 280 in FIG. 2E may be the selected for recommendation. Recommendations may relate to communication parameters for an optical link in the network between the CU, the DU and the RU, or a combination of these. In an example, the parameters recommended by the ML model or DL model for the network route may include a modulation format, such as 64-QAM or 16-QAM or any other suitable modulation format. In another example, the parameters recommended by the ML model or DL model for the network route may include a forward error correction (FEC) technique. In another example, the parameters recommended by the ML model or DL model for the network route may include one or more data rates for the selected network route. In another example, the parameters recommended by the ML model or DL model for the network route may include a selected bandwidth for communication over the selected network route.

The ML model or DL model or other AI component in embodiments operates to optimize the reachability for each selected optical network route. Optical reach or reachability refers to the distance between an optical transmitter and optical receiver, or the length of an optical fiber or other connection, over which data may be reliably transmitted and received. Optical reach is the distance an optical signal can travel before needing to be regenerated. Longer optical reach corresponds with a smaller number of required regenerations and hence less equipment and lower operating costs. Reachability is a function of a number of parameters including modulation technique, number of channels present, and forward error correction techniques employed. Reachability is also a function of parameters such as gain profile, absorption losses, scattering and dispersion. The material properties of the optical fiber are also a factor in reachability.

Further, or instead, the SDAOC 210 may recommend the best or an optimal space in spectrum to launch a channel on the network, based upon results of the ML model as well rule-based policy engine at step 276. For example, when launching the best spectral efficiency channel, the SDAOC 210 or other device or process automatically pick the number of channels and location of those channels in the flex grid based upon distance. Flex grid refers to an arrangement in which channel spacing is flexible and not fixed. Due to non-linearities in the optical fiber and varying gain profiles, different channels will have varying properties. No two channels will have same gain profile and hence may have different reach. Using the collecting information and the ML model or DL model, the SDAOC operates to pick a best suited location in the flex grid for channels between two ends of network. The location in the flex grid or spectrum is defined by a wavelength and a spectral width for each wavelength.

In another example, a network component such as a CU, a DU or an RU may be operating outside of performance requirements. For example, a standard such as a standard published by 3GPP for network communication in a 5G fronthaul network may specify minimum performance parameters such as error rate or data rate. The ML model, DL model or other AI tool may determine, based on the network information collected at step 274, that the network component is failing to reliably meet the requirement of the standard. For example, the SDAOC 210, relying on the rule engine 262 or policy engine 260, may compare actual performance as reflected in the collected network data with a rule or policy describing the requirement of the standard. In response, the ML model or DL model develops a recommendation, based on all the information collected about the network, to modify physical aspects of the one or more components of the network to ensure the standard is met. In an example, the ML model may recommend a change to an existing channel, such as moving the channel to a different wavelength in the spectrum, to help the channel better meet the 3GPP requirements. The network operator may thereafter reconfigure one or more network components according to the modified parameters recommended by the ML model or other AI tool. Thus, the method 270 modifies spectrum usage and definition to resolve a functional or reliability problem in the network.

At step 279, the method 270 includes implementing the recommendation. For example, the SDAOC 210 may recommend that a new channel may be positioned at a particular wavelength v and at a particular spectral width. The SDAOC 210 may further recommend a particular data rate for the new channel, such as 1 Gbps. Moreover, the SDAOC 210 may recommend a particular error correction technique such as Enhanced FEC, and a particular data type, such as a fiber channel connection. The recommendations apply to a particular network route between a first network element, such as a CU, and a second network element such as a DU or RU. The recommendation is based on all the information collected about the physical network.

Based on the recommended parameters, a new channel is launched or defined for the specified particular network route, between the two specified network elements. The new channel may be tuned according to the recommended parameters. In some examples, new equipment may be positioned and activated in the network to launch the new channel. In some examples, the SDAOC may compute an impact of moving channels in spectrum. Some movements of existing channels may result in performance degradation for those channels. The SDAOC may define a maintenance window when action may be taken to redefine affected channels. During that time, the network components on each end of a network route are reprogrammed to define the preexisting channel at a new location in spectrum, with new channel parameters. The SDAOC may, in fact, define the reprogramming to occur automatically during a predefined maintenance window for the network equipment.

Accordingly, the system and method in accordance with the disclosure herein provides a unique method and apparatus for allocating spectrum in an optical network such as a 5G optical fronthaul network. The functions of the SDAOC described herein assist in the spectrum allocation. Further, the system and method simplify the problem of defining a hole in the operating spectrum for freshly launched channels. In other applications, the system and method maybe used in conjunction with a ML or DL model to defragment spectrum in a functioning network with minimal or no impact on existing traffic in the network.

While for purposes of simplicity of explanation, the respective processes are shown and described as a series of blocks in FIG. 2D and FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

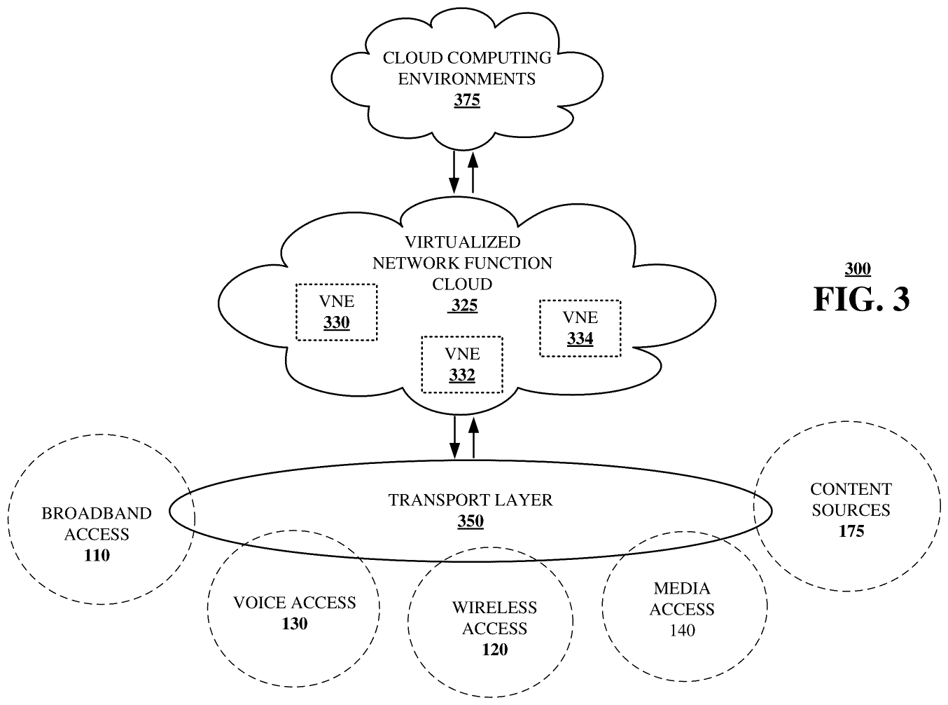

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIG. 1, FIG. 2A, FIG. 2B, FIG. 2D, FIG. 2E, and FIG. 3. For example, virtualized communication network 300 can facilitate in whole or in part determining physical parameters the components and connections of a network. The physical parameters of the network may be used to model network topology using an artificial intelligence tool and parameters for a new or modified channel in the network may be received from the model. The new or modified channel may then be launched by the network to initiate communication between the two components.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

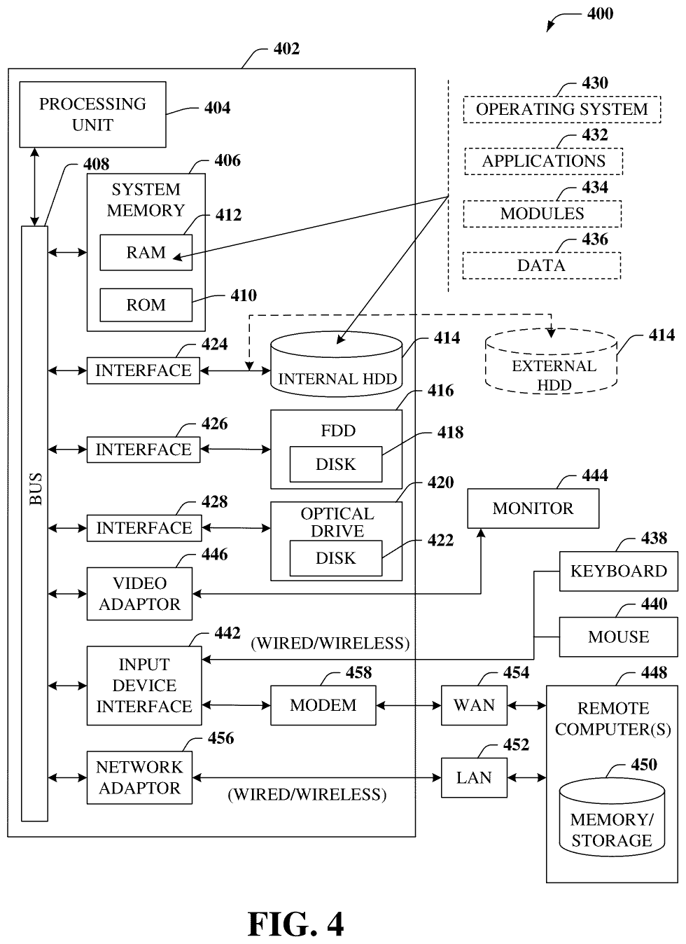

Turning now to FIG. 4, there is illustrated a block diagram of a computing environment 400 in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part determining physical parameters the components and connections of a network. The physical parameters of the network may be used in a computing environment such as the computing environment 400 to model network topology using an artificial intelligence tool and parameters for a new or modified channel in the network may be received from the artificial intelligence tool. The new or modified channel may then be launched by the network to initiate communication between the two components.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

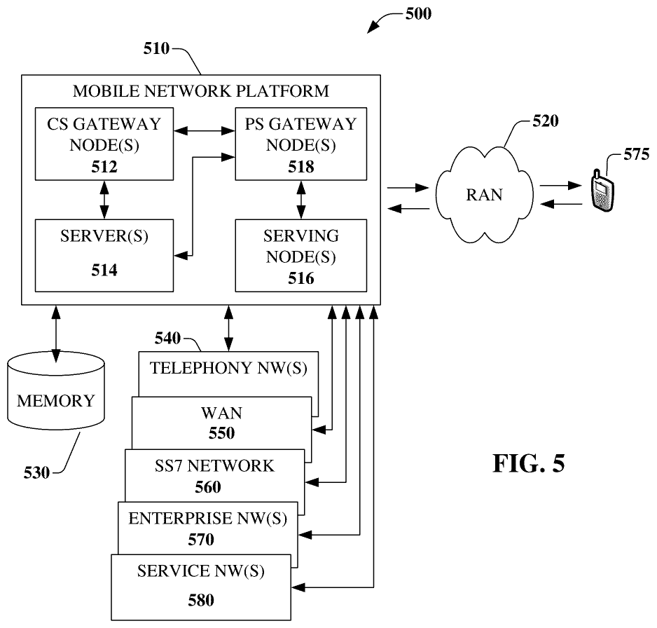

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part for determining physical parameters the components and connections of a network such as portions of the mobile network platform 510. The physical parameters of the network may be used to model topology using an artificial intelligence tool such as a machine learning model and parameters for a new or modified channel in the network may be received from the artificial intelligence tool. The new or modified channel may then be launched by the network to initiate communication between the two components. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

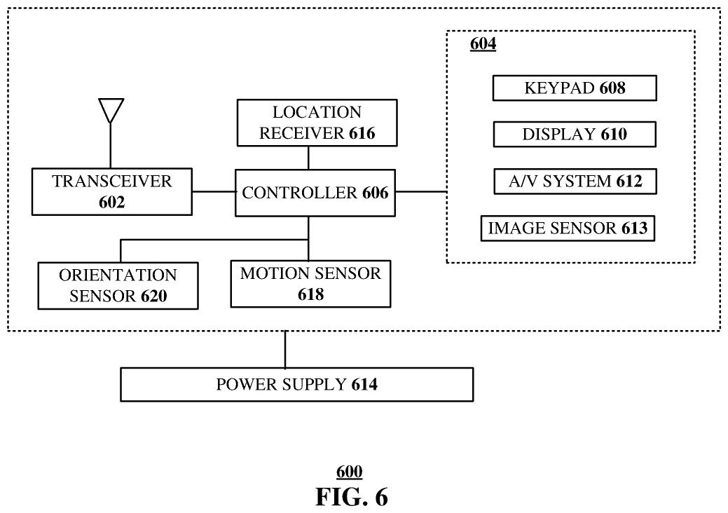

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part determining physical parameters the components and connections of a network such as a mobility network including the communication device 600. The physical parameters of the network may be used to model topology using an artificial intelligence tool such as a deep learning model and parameters for a new or modified channel in the network may be received from the model. The new or modified channel may then be launched by the network to initiate communication between the two components.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
collecting network information about physical parameters of an optical transport network, the optical transport network including multiple network elements, the network elements including at least one of a Central Unit (CU), a Distributed Unit (DU) and a Radio Unit (RU), forming collected network information;
developing a machine learning (ML) model for characterizing at least a portion of the optical transport network, wherein the developing the ML model is based at least in part on the collected network information;
selecting parameters for a communication channel between two network elements, forming selected parameters; and
launching the channel between the two network elements according to the selected parameters.

2. The device of claim 1, wherein the operations further comprise:
determining a functional failure by a particular network element of the multiple network elements; and
modifying one or more of spectrum usage and spectrum definition for the communication channel to correct the functional failure.

3. The device of claim 2, wherein the determining the functional failure by the particular network element comprise:
identifying a performance parameter of an existing channel that fails to meet a published specification.

4. The device of claim 2, wherein the operations further comprise:
identifying the functional failure between one of a respective CU and a respective DU, the functional failure occurring because a distance between the respective CU and the respective DU exceeds a permitted threshold for reliable communication;
identifying an improved channel between the respective CU and the respective DU having optimal spectral efficiency to correct the functional failure; and
launching the improved channel for communication between the respective CU and the respective DU.

5. The device of claim 4, wherein the identifying the improved channel comprises:
selecting a wavelength of the improved channel, the wavelength selected from a flex grid to improve spectral efficiency of the improved channel.

6. The device of claim 1, wherein the collecting network information about physical parameters of an optical transport network comprises:
collecting information about distances between the network elements including the at least one of a Central Unit (CU), a Distributed Unit (DU) and a Radio Unit (RU);
collecting information about gain profiles of channels between the network elements;
collecting information about absorption losses in optical fibers of the optical transport network; and
collecting information about scattering in the optical fibers of the optical transport network.

7. The device of claim 6, wherein the selecting parameters for the communication channel between two network elements comprises:
selecting a spectrum location for the communication channel.

8. The device of claim 1, wherein the operations further comprise:
detecting a change in network performance due to a physical variation in a network element or a network route of the optical transport network; and
selecting, by the ML model, revised parameters for the communication channel to compensate for the change in network performance due to the physical variation.

9. The device of claim 1, wherein the selecting parameters for the communication channel between the two network elements comprises:
automatically selecting a number of channels and a spectrum location for each respective channel of the number of channels.

10. The device of claim 9, wherein the automatically selecting a number of channels and a spectrum location comprises:
selecting the number of channels and the spectrum location based on a distance between a respective CU, a respective DU and a respective RU.

11. A non-transitory machine-readable medium, comprising executable instructions that, when executed by a processing system including a processor, facilitate performance of operations, the operations comprising:
collecting information about physical parameters of an optical transport network in a mobility network, the optical transport network including multiple network elements, the network elements including at least one of a Central Unit (CU), a Distributed Unit (DU) and a Radio Unit (RU) for providing radio communication services to user equipment (UE) devices in a service area, forming collected network information;
detecting a network failure in the optical transport network;
receiving, from a model, suggested parameters for a modified channel in the optical transport network, the suggested parameters determined by the model to correct the network failure in the optical transport network; and
launching the modified channel according to the suggested parameters.

12. The non-transitory machine-readable medium of claim 11, wherein the collecting information about physical parameters of the optical transport network comprises:
capturing information about respective network elements of the multiple network elements;
capturing information about respective network routes between respective network elements;
modeling a network topology of the optical transport network, wherein the modeling the network topology is based on the information about the respective network elements and the information about respective network routes; and
storing information defining the network topology for access by the model.

13. The non-transitory machine-readable medium of claim 12, wherein the operations further comprise:
predicting a spectral efficiency for the respective network routes, wherein the predicting the spectral efficiency is based on the information about physical parameters of the optical transport network.

14. The non-transitory machine-readable medium of claim 11, wherein the collecting information about physical parameters of the optical transport network comprises:
identifying respective network routes between respective network elements of the optical transport network;
receiving information about one or more of possible data rates, available modulation techniques, and available forward error correction techniques for respective network routes between respective network elements, forming received network link information; and
developing the model as a machine learning model based on the received network link information.

15. The non-transitory machine-readable medium of claim 14, wherein the operations further comprise:
receiving, from the model, channel parameters corresponding to an optimal spectral efficiency for the modified channel, the optimal spectral efficiency determined by the model to be a spectral efficiency to correct the network failure in the optical transport network.

16. The non-transitory machine-readable medium of claim 15, wherein the operations further comprise:
receiving, from the model, a channel wavelength for the modified channel.

17. A method, comprising:
receiving, by a processing system including a processor, network information about physical parameters of a fronthaul network of a mobility network, the fronthaul network including multiple network elements including optical communication elements of a radio access network of the mobility network, forming collected network information;
receiving, by the processing system, from a deep learning (DL) model, operating parameters for a channel in the fronthaul network, the operating parameters determined by the DL model for improved spectral efficiency in the channel between a first element and a second element in the fronthaul network; and
launching, by the processing system, the channel between the first element and the second element, wherein the launching the channel is according to the operating parameters.

18. The method of claim 17, further comprising:
receiving, by the processing system, information about respective network elements of the fronthaul network;
receiving, by the processing system, information about respective optical network routes between the network elements of the fronthaul network;
modeling, by the processing system, a network topology of the fronthaul network, wherein the modeling the network topology is based on the information about the respective network elements and the information about respective optical network routes; and
storing information defining the network topology for access by the model.

19. The method of claim 17, comprising:
predicting, by the processing system, a spectral efficiency for the respective optical network routes, wherein the predicting the spectral efficiency is based on the information about the physical parameters of the fronthaul network.

20. The method of claim 17, wherein the receiving the operating parameters comprises:
receiving, by the processing system, a spectrum location for the channel in the fronthaul network.
